(19) United States
(12) Patent Application Publication
(10) Pub. No.: US 2017/0293881 A1
(43) Pub. Date: Oct. 12, 2017

(54) WAREHOUSING AND DELIVERY SYSTEMS AND METHODS WITH CROSS-RETAILER FULFILLMENT

(71) Applicant: BIGLYNX INC., Bellevue, WA (US)

(72) Inventor: Pavan Kumar Narkulla, Redmond, WA (US)

(21) Appl. No.: 15/479,565

(22) Filed: Apr. 5, 2017

Related U.S. Application Data
(60) Provisional application No. 62/320,000, filed on Apr. 8, 2016.

(51) Int. Cl. G06Q 10/08; G06K 7/14; G06Q 30/06

(52) U.S. Cl. CPC G06Q 10/087; G06Q 30/0635; G06Q 10/083; G06K 7/1413

(57) ABSTRACT

The present disclosure provides methods and systems for the storage, ordering, listing, and delivery of products. Warehousing and delivery fulfillment systems are provided. Also provided are methods of warehousing and delivery fulfillment.

### CROSS-REFERENCE

This application claims the benefit of U.S. Provisional Application No. 62/320,000, filed Apr. 8, 2016, which is incorporated herein by reference in its entirety and to which application we claim priority under 35 USC §120.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND OF THE INVENTION

Manufacturers, retailers, and distributors must store and deliver great quantities of products at a time. It is not uncommon to have hundreds if not thousands of products. The storage and delivery of products to customers distributed across a large geographic area in a timely manner presents significant challenges. Orders are received from customers and material handling systems must locate inventory and then route the inventory necessary to fill the orders to an appropriate location for shipping or delivery. Often, products stored in large warehouses are located far from the delivery address of a customer, leading to longer delivery times or higher delivery costs. Accordingly, methods are needed to more efficiently identify demanded products and deliver them to customers, while minimizing the time and cost of delivery.

### SUMMARY OF THE INVENTION

The present disclosure provides methods and systems for the storage, ordering, listing, and delivery of products.

In one aspect, a warehousing and delivery fulfillment system is provided. The system comprises a computer network, a non-transitory computer-readable storage medium, a processor, and memory. The memory comprises instructions executable by the processor. When executed, the instructions cause the processor to perform a sequence of steps. The processor receives from the computer network, property listings from a plurality of property managers. Each property listing identifies a warehousing property. The processor generates, based on the received property listings, a database of warehouse listings corresponding to the identified warehousing properties. The processor further receives, from the computer network, storage space requests from one or more retailers. Each storage space request identifies a product to be stored. The processor assigns each storage space request to a corresponding warehousing space of one or more of the warehousing properties and generates a product database identifying the products assigned to each warehouse. The processor receives, from the computer network, a purchase order requesting that a product of a retailer be delivered to a customer address. The processor selects a product from the product database that corresponds to the requested product. The selection is determined based on selection criteria including the customer address and the warehouse to which the product is assigned. The processor sends, using the computer network, a delivery request to deliver to the customer the selected product.

In some embodiments, each warehouse listing identifies a warehouse location and/or a warehouse storage capacity. The system can he configured to record in the database a total storage space for each warehouse listing. The system can also be configured to track available storage space for each warehouse listing in the database. In some embodiments, the system is further configured to identify a storage type for each warehouse listing.

In some embodiments, the purchase order is from a first retailer, whereas the selected product is a product of a second retailer. The product database can comprise price listings for third-party fulfillment; in such cases, the selection criteria include said price listings for third-party fulfillment. The processor can he configured to receive third-party fulfillment prices from the one or more retailers, and the price listings for third-party fulfillment can be determined therefrom.

In some cases, each product is identified by a barcode. The system can be further configured to receive barcode scans identifying product arrivals and departures from a warehousing property. The system can also track inventory for a warehousing property by incrementing a product count in response to each product arrival and decrementing said product count in response to each product departure.

In some embodiments, the system is configured to identify, for each warehouse listing, an available storage space, a storage price, and a storage location. The system can be further configured to allow a user to search for storage space in response to at least one of the available storage space, the storage price, or the storage location. The system can also be configured to allow a user to request storage space based on one or more of an amount of required storage space, a maximum storage price, or a preferred storage location, and wherein the system identifies one or more warehousing options based on said user request.

In some embodiments, the system is further configured to receive fulfiller data from the computer network. The fulfiller data includes availability, pricing, and delivery area data for a plurality of delivery fulfillers. The system is configured to determine, based on a location of the identified warehousing space, one or more delivery fulfillers for which the identified warehousing space and the customer address are within a corresponding delivery range. The system is configured to send a fulfillment request to the one or more delivery fulfillers identifying the requested delivery, using the computer network, and to receive from the network one or more responses from the one or more delivery fulfillers. The system is configured to send, using the computer network, the delivery request to a delivery fulfiller of the one or more delivery fulfillers based on the responses. In some cases, the delivery fulfiller is determined by comparing the fulfiller responses to delivery preferences specified by the retailer for which the product is to be delivered.

In another aspect, a method of warehousing and delivery fulfillment is provided. The method comprises receiving, from a computer network, property listings from a plurality of property managers. Each property listing identifies a warehousing property. The method further comprises generating, with a processor, based on the received property listings, a database of warehouse listings corresponding to the identified warehousing properties; receiving, from the computer network, storage space requests from one or more retailers, each storage space request identifying a product to be stored; and assigning, with the processor, each storage space request to a corresponding warehousing space of one or more of the warehousing properties. A a product database is generated, which identifies the products assigned to each warehouse. A purchase order requesting that a product be delivered to a customer address is received from the computer network; and a product is selected from the product database. The product selected corresponds to the requested product, and the selection is determined based on selection criteria including the customer address and the warehouse to which the product is assigned. A delivery request to deliver to the customer the selected product is sent using the computer network.

In some embodiments, each warehouse listing identifies a warehouse location and/or a warehouse storage capacity. The method can also include recording in the database a total storage space for each warehouse listing. Available storage space can be tracked for each warehouse listing in the database. In some embodiments, the method further comprises identifying a storage type for each warehouse listing.

In some embodiments, the purchase order is from a first retailer, whereas the selected product is a product of a second retailer. The product database can comprise price listings for third-party fulfillment; in such cases, the selection criteria include said price listings for third-party fulfillment. The method can include receiving third-party fulfillment prices from the one or more retailers, and the price listings for third-party fulfillment can be determined therefrom.

In some cases, each product is identified by a barcode. The method can further comprise receiving barcode scans identifying product arrivals and departures from a warehousing property. Inventory can also be tracked for a warehousing property by incrementing a product count in response to each product arrival and decrementing said product count in response to each product departure.

In some embodiments, the method further comprises identifying, for each warehouse listing, an available storage space, a storage price, and a storage location. The method can also include allowing a user to search for storage space in response to at least one of the available storage space, the storage price, or the storage location. A user can also be allowed to request storage space based on one or more of an amount of required storage space, a maximum storage price, or a preferred storage location, and one or more warehousing options can be identified based on said user request.

In some embodiments, method further comprises receiving fulfiller data from the computer network. The fulfiller data includes availability, pricing, and delivery area data for a plurality of delivery fulfillers. One or more delivery fulfillers are determined, based on a location of the identified warehousing space, for which the identified warehousing space and the customer address are within a corresponding delivery range. A fulfillment request is sent to the one or more delivery fulfillers identifying the requested delivery, using the computer network, and one or more responses are received over the computer network from the one or more delivery fulfillers. The delivery request is sent, using the computer network, to a delivery fulfiller of the one or more delivery fulfillers based on the responses. In some cases, the delivery fulfiller is determined by comparing the fulfiller responses to delivery preferences specified by the retailer for which the product is to be delivered.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the invention are utilized, and the accompanying drawings of which:

FIG. 1 shows a schematic diagram for a warehousing and delivery fulfillment system, in accordance with embodiments;

FIG. 2A shows a detailed diagram of platform 110 of FIG. 1;

FIG. 2B shows a detailed diagram of a subsystem for property holders 120 of FIG. 1;

FIG. 2C shows a detailed diagram of a subsystem for retailers 130 of FIG. 1;

FIG. 2D shows a detailed diagram of a subsystem for fulfillers 140 of FIG. 1;

FIG. 3 illustrates a process 300 by which a retailer provides product listings for cross-retailer inventory, in accordance with embodiments;

FIG. 4 illustrates a process by which a first retailer can arrange the fulfillment of warehoused products of a second retailer, in accordance with embodiments;

FIG. 5 illustrates a method of warehouse fulfillment pricing based on fulfiller delivery time, in accordance with embodiments;

FIG. 6 illustrates a method of coordinating retailer and fulfiller orders in the delivery of products for a plurality of orders, in accordance with embodiments;

FIG. 7 illustrates a method of fulfiller selection based on geographical criteria, in accordance with embodiments;

FIG. 8 illustrates a method of warehouse space listing, in accordance with embodiments;

FIG. 9 illustrates a method of allocation of warehousing space, in accordance with embodiments; and

FIG. 10 is a simplified block diagram of a data processing system which may be used to implement the systems and methods disclosed herein.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figure and described in the specification, but only as indicated in the accompanying claims, with the proper scope determined only by the broadest interpretation of said claims.

As used herein the term “and/or” is used as a functional word to indicate that two words or expressions are to be taken together or individually. For example, A and/or B encompasses A alone, B alone, and A and B together.

A better understanding of the features and advantages of the present disclosure will be obtained by reference to the following detailed description that sets forth illustrative embodiments, in which the principles of embodiments of the present disclosure are utilized, and the accompanying drawings.

The embodiments disclosed herein can be combined in one or more of many ways to provide improved spectrometer methods and apparatus. One or more components of the configurations disclosed herein can be combined with each other in many ways. A warehousing fulfillment system as described herein can be used to coordinate warehouse space listing, storage of items in warehouses, and fulfillment of delivery requests from said warehouses. The systems described herein comprise computer networks configured to send and receive data, allowing efficient coordination of warehouse and product listing, as well as product delivery in response to customer orders. In some cases, a cloud based server may be provided in order to perform one or more of the methods described herein.

The embodiments disclosed herein also make use of databases for managing and tracking warehouses, products, retailers, fulfillers, customers and other components of the systems disclosed herein. A mobile communication device can be configured for users to interface with servers of the systems disclosed herein, in order to allow management of warehouse property listings, product storage, product ordering, delivery requests, fulfiller tracking, and delivery confirmation.

As used herein, a warehouse comprises any place in which products or merchandise may be stored, including but not limited to large and small commercial warehouses, garages, homes, storage spaces, and other properties capable of storing products.

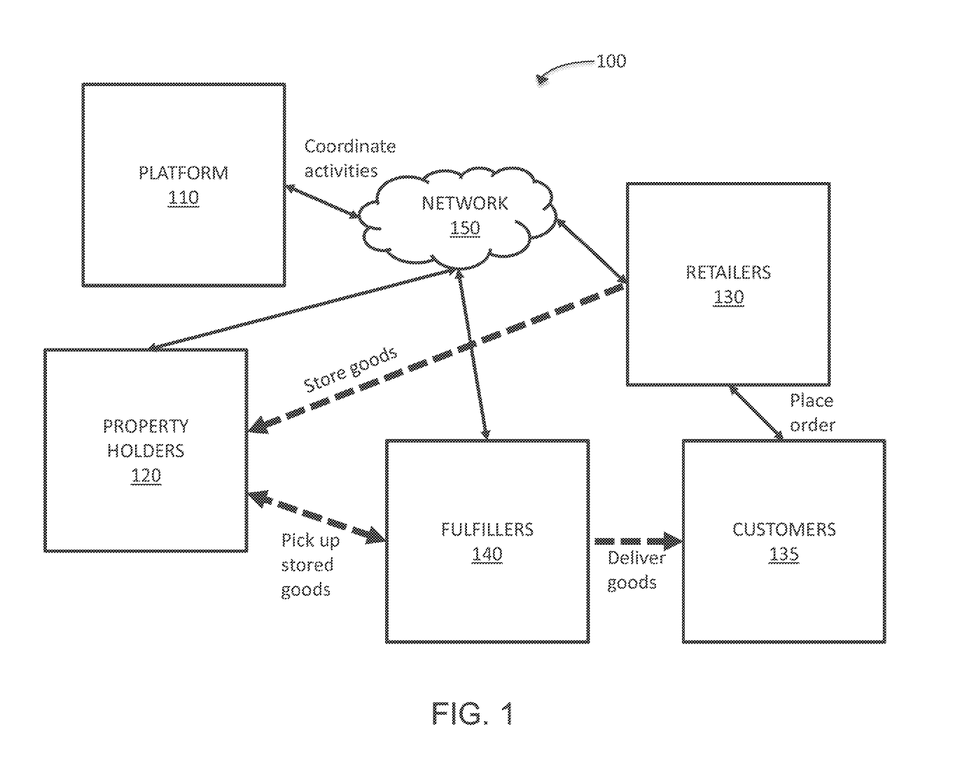

FIG. 1 shows a schematic diagram for a warehousing and delivery fulfillment system 100, in accordance with embodiments. The system comprises a platform 110 which manages the listing of warehouse space, the receipt and storage of products within the warehouse space, the receipt of orders to deliver the products within the warehouse space, the identification of products to be delivered, and the fulfillment of delivery by fulfillers. In performing these tasks, the platform 110 can perform the methods disclosed herein, discussed in detail below. In order to coordinate these activities, the platform is connected to a network 150. Also connected to the network are property holders 120, retailers 130, and fulfillers 140. Broadly, the property holders provide warehousing space, and indicate available space and pricing data to platform 110. Platform 110 provides warehousing space information to retailers 130, who purchase storage space for the storage of products. In some cases, the retailers 130 also provide storage space, either by placing it up for rental or by storing their own products in such storage space (which may correspond to “purchase” of storage space at a price of 0). The purchase of storage space may be in exchange for money, and/or “in kind” purchase; for example, a retailer may provide storage space to the system in exchange for other storage space elsewhere. The retailers 130 store products in the storage spaces registered with the system, and receive purchase orders from customers 135. The retailers 130 notify the platform 110 of a delivery request of a product to be delivered to a customer address. The platform 110 notifies one or more fulfillers 140 of the delivery request, and the fulfillers 140 respond by picking up the products for delivery, which may be tracked by the platform, and delivering the products to the customers 135.

The network connections may comprise a combination of cellular, broadband, Ethernet, and other network connections, including wireless connections of any type, electrical and optical connections, and so forth. The connections of fulfillers 140, retailers 130, and property holders 120 to network 150 may be continuous or discontinuous, and may be synchronous or asynchronous, depending on the needs of each party. The platform 110 should preferably be continuously connected to the network 150 so as to always allow prompt connections to the platform for each party, as needed.

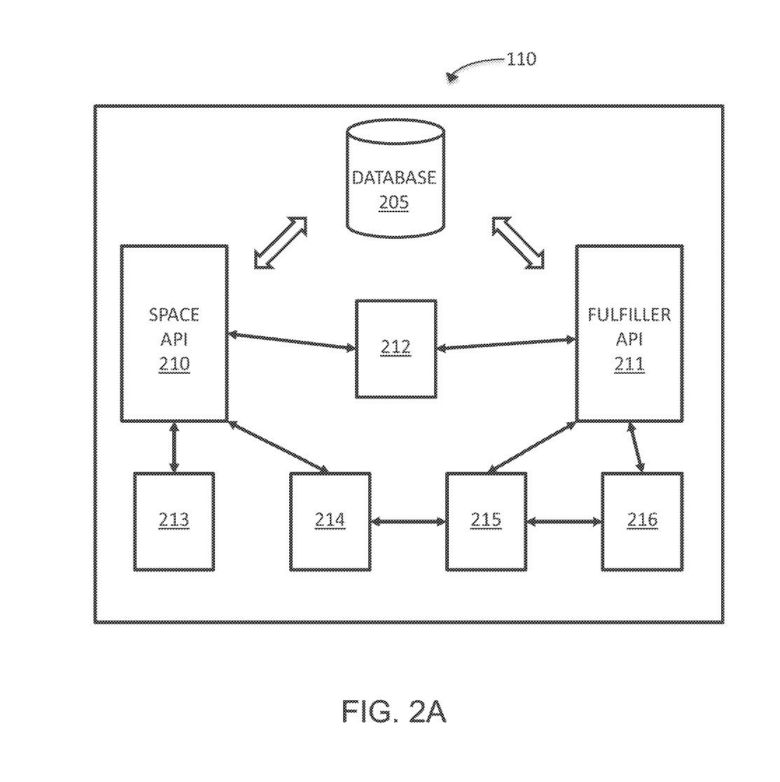

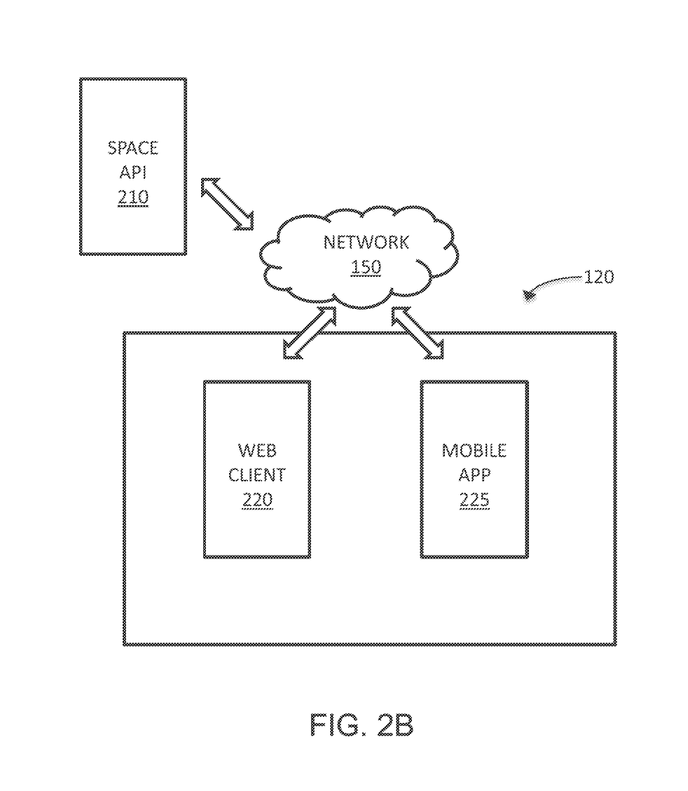

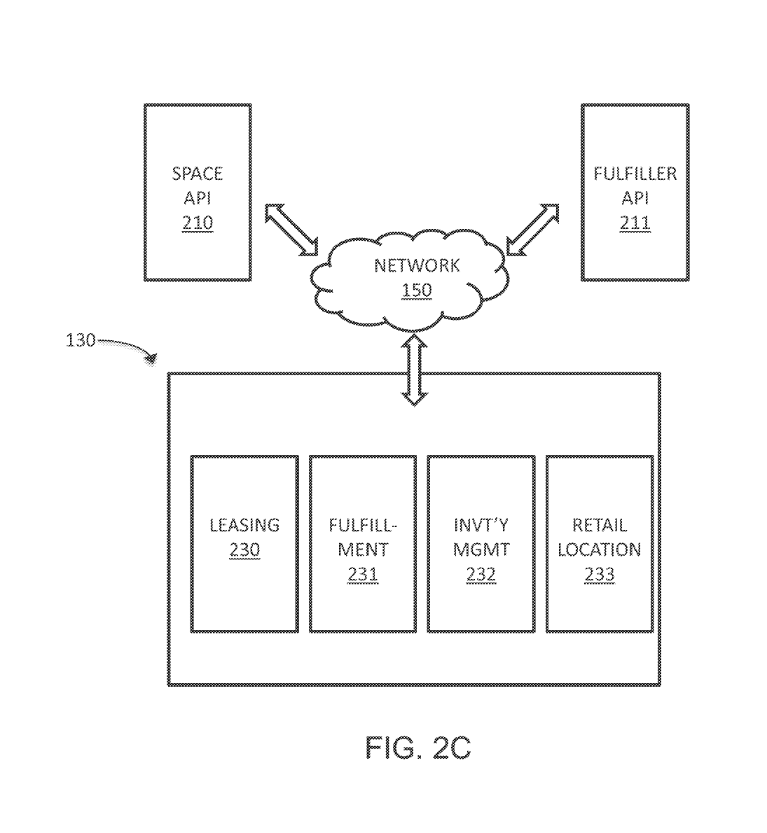

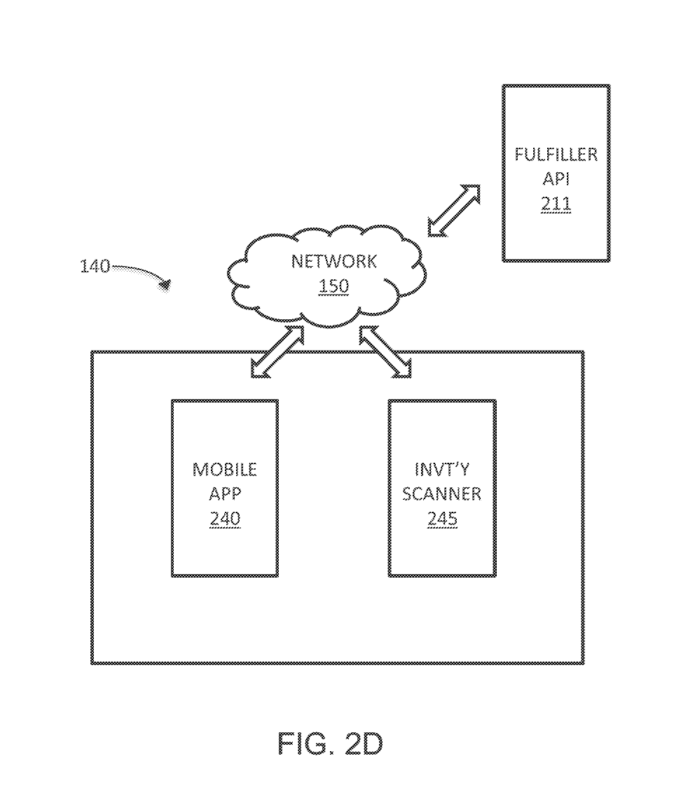

FIG. 2A shows a detailed diagram of platform 110 of FIG. 1. Platform 110 comprises a database 205 for storing information related to warehousing space listing, warehouse space leasing, inventory tracking, and delivery fulfillment. Platform 110 comprises a processor and memory, and the memory comprises instructions that when executed cause the processor to generate a plurality of modules for performing functions related to warehousing, inventory management, and delivery. In order to interface with users wishing to list and lease warehouse space, a warehouse space module, such as warehouse space API 210, is provided to allow management of such warehousing space. A second module, fulfiller API 211, is provided to allow for inventory management and order fulfillment. Users accessing platform 110 may initially interact with onboarding system 212. Onboarding subsystem 212 may comprise features such as an internet home page and options such as signup and registration; subscription; and links to features such as pricing and offers, billing, and space provisioning options. After signing in, a user may be directed to an API appropriate to the user's needs; property owners and managers can interact with the warehouse space API 210, while fulfillers would interact with the fulfiller API 211. Retailers can interact with both API 210 and API 211, as they act simultaneously as lessors of warehousing space and requesters of inventory delivery from fulfillers.

Warehousing space API 210 receives new property listings from users via listing subsystem 213. The listing system receives descriptions of available space from users, including such features as images, location, available space, available times, and prices. Type of facility and storage may be indicated—for example, storage or facility type may include garage storage, large warehouse storage, open/non-enclosed storage, or special features of storage such as refrigeration or climate control. Based on the input of the user making a listing, a database entry is made in database 205 to allow the listing of the storage space, which may be accessed, for example, by leasing subsystem 214. Leasing subsystem 214 enables the leasing of warehouse storage in warehouses listed by listing subsystem 213. Users such as retailers can access a list of property listings to see features such as location, price, space available, and time available. Users select among offered lease terms, including duration, amount of space, price, and warehouse type and location. Users may also set up periodic notifications, such as notifications of new storage available or of changes in price. Selection may be made on an individual basis, such as selection of particular warehouses on a map, or by large scale allocations of products to each of a plurality of geographic areas. In the latter case, the leasing subsystem 214 automatically assigns sufficient storage space to meet the demanded quantity.

After arranging to lease space in a warehouse, retailers can arrange to ship products to be stored therein. As products arrive in the warehouse, they are inventoried by inventory subsystem 215. For each vendor, database 205 tracks number of units of the product at each warehouse. Each type of product can be assigned a unique code, such as a barcode, RFID code, QR code, or other identifying code, which can be scanned by an appropriate scanner upon delivery to the warehouse. The code may contain UPC or SKU identification, or such identification may be determinable from the code, for example. The scans are transmitted over the internet to platform 110, which updates the corresponding database entry. Because multiple retailers can store their products in the warehouses managed by platform 110, retailers can be given the option of cross-retailer fulfillment of orders. Inventory subsystem 215 can process the data in database 205 to generate a catalog of all products of each of a plurality of types that are stored in warehouses listed by listing subsystem 213. Retailers may be permitted to opt in or out of such catalog features, including the option of listing some units of each product while holding others in reserve to ensure availability. For the products they choose to cross-list in this manner, retailers can identify a cross-listing price, which may be different from either wholesale or retail prices. When requesting cross-retailer fulfillment, a retailer can be presented with a listing of different cross-retailer offers, including prices, locations, and delivery times. A retailer can then choose a third party retailer for cross-retailer fulfillment, or opt to have his own products delivered from their respective warehouse(s).

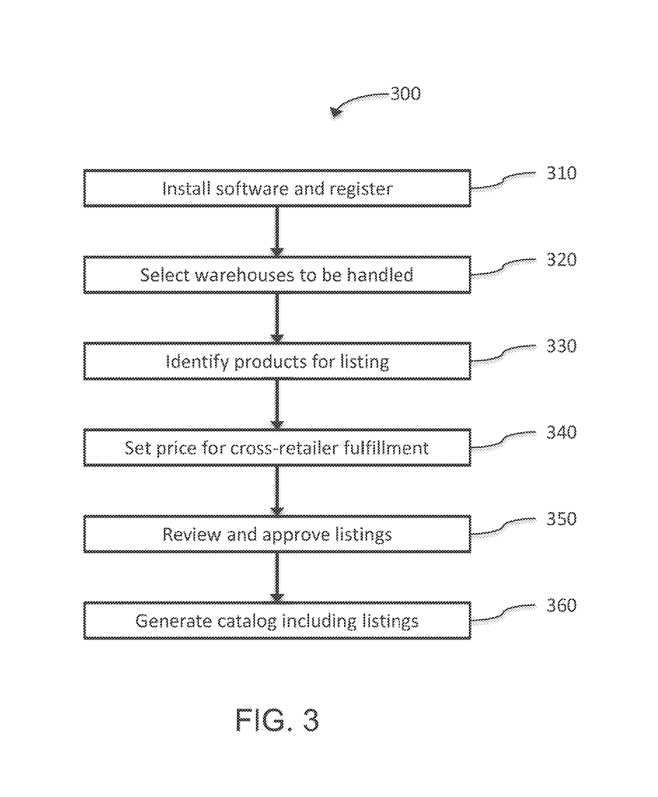

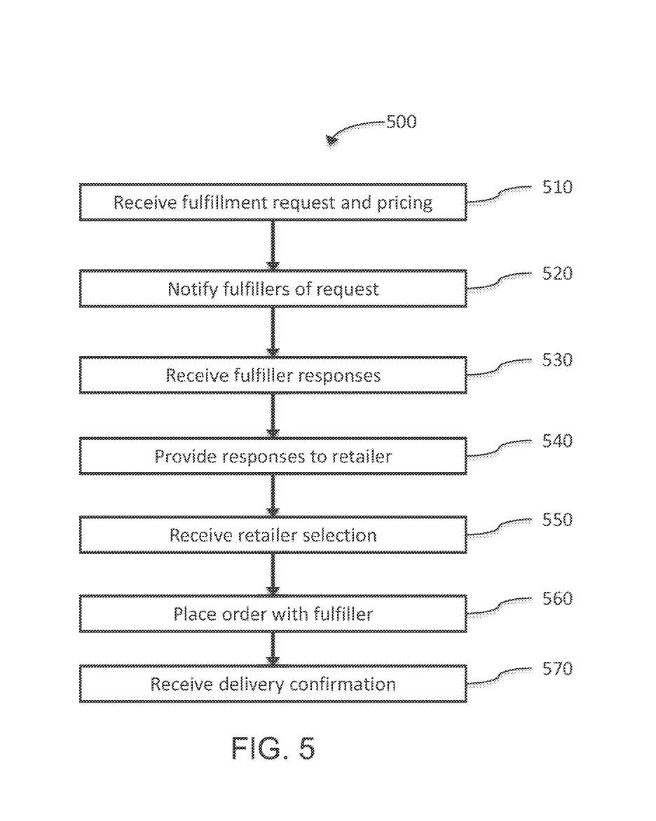

Once an order has been made and a product has been selected for delivery, fulfiller subsystem 216 selects a fulfiller. The method of selection may, for example, include the methods of fulfiller selection described below in relation to FIGS. 5-7. Criteria for selection can include geographic location, price, fulfiller rating, and fulfiller availability, for example. During fulfillment, the selected fulfiller travels to the appropriate warehouse and picks up the products to be delivered. In picking up the products, the fulfiller notifies platform 110 of the pickup, for example, by sending a message from a mobile device of the fulfiller, which is received and processed by inventory subsystem 215. In some cases, the message is sent automatically in response to scanning or otherwise providing a code for the product, such as a barcode, RFID code, QR code, or other identifying code. The fulfiller then delivers the product to the customer address provided by the retailer, and sends a message confirming the delivery, which is received by the platform and processed by inventory subsystem 215, which decrements the count of the product at that warehouse. The delivery confirmation message may be sent, for example, in response to a code scan similar to the scan for pickup described above. The platform 110 then sends a confirmation message to the retailer, and platform 110 prepares appropriate invoices for payments from the retailer and to the fulfiller. The processes performed by platform 110 to provide each of the functions disclosed herein are described in greater detail below, for example, in reference to FIGS. 3-9.

FIG. 2B shows a detailed diagram of a subsystem for property holders 120 of FIG. 1. Property holders are allowed to access platform 110 to list properties with available storage space. Property holders connect to platform 110 over a network 150 using a computing device, such as a computer or a mobile device. The connection is handled on the platform side by space API 210. The property holder computing device is provided processor-executable instructions, for example in the form of HTML, browser-executable code, device apps, or an API. The instructions, when executed, provide a property holder subsystem 120, as illustrated in FIG. 2B. The subsystem may comprise a web client 220, and/or a mobile app 225 running on the user's computing device. A user may register an account through either or both, and an account registered in the client 220 can connect, using appropriate authentication, through the mobile app 225, or vice-versa. Through web client 220 or mobile app 225, the user provides identifying information including financial information, to allow payments for leased space to be forwarded by platform 110 to an appropriate account of the user. The user also provides information regarding properties the user wishes to list for storage in warehouses. The information provided can include descriptions of available space from the user, including, for example, warehouse location, available space, available times, and prices. Type of facility and storage may be indicated—for example, storage or facility type may include garage storage, large warehouse storage, open/non-enclosed storage, or special features of storage such as refrigeration or climate control. These data are used to create a database entry for the property, as described above in reference to FIG. 2A.

In some cases, the user is a retailer, and the retailer provides information regarding warehousing space and products stored to platform 110 without listing any storage space for lease—in such cases, the retailer can still enjoy the benefits of the automatic fulfillment systems and cross-retail fulfillment without needing to provide or rent warehouse space. In that case, the warehouse space may be treated as offered by and sold to the same user, with storage of that user in the user's own warehouse.

FIG. 2C shows a detailed diagram of a subsystem for retailers 130 of FIG. 1. As in the case of the property holders, retailers can connect using a computing device, such as computer or a mobile device. Because retailers interact with both the warehousing and the inventory/fulfillment aspects of system 100, the connection can be handled on the platform side by space API 210 or fulfiller API 211, as appropriate for a given transaction. The retailer computing device is provided processor-executable instructions, for example in the form of HTML, browser-executable code, device apps, or an API. The instructions, when executed, provide a retailer subsystem 130, as illustrated in FIG. 2C. The subsystem may comprise a web client, and/or a mobile app running on the retailer's computing device. The retailer subsystem 130 comprises a plurality of modules 230-234, each of which is configured to handle a corresponding type of interaction with platform 110.

Leasing module 230 allows retailers to search for warehouses listed in database 205; request quotes of availability and price for leasing space; and arrange a lease of listed warehousing. Leasing module 230 connects through space API 210 of platform 110. Upon leasing warehousing space, the retailer can arrange to have inventory shipped there and stored for future deliveries. Fulfillment module 231 allows retailers to search for fulfillers for deliveries from nearby warehouses; subscribe fulfillers to within a proximity zone of one or more warehouses; and provide criteria for automated fulfiller choices, such as pricing and delivery time thresholds. Based on the selections and settings of the retailer, the platform 110 can select fulfillers for each delivery order sent by retailers. Fulfillment module 231 allows a retailer to send an order for delivery of a product in a warehouse (as recorded in database 205) to a specified address. A fulfiller is selected by the platform 110 in accordance with retailer preferences, which may include providing a list of fulfillers for the retailer to approve or choose among. The platform then arranges for the fulfiller to deliver the product, which is handled by fulfiller API 211 and fulfiller subsystem 240.

Retailers are provided the ability to manage their inventory in leased warehouses as well as their own warehouse space using inventory management module 232 and retail location module 233. Inventory management module 232 allows retailers to register and track inventory stored in warehouses. Retailers can choose settings through inventory management module 232 such as product coding identification (for example, identifying products using SKU), pricing (including cross-retail fulfillment pricing), and warehouse inventory preferences (such as thresholds for products, specifying a reserve of products not to deliver in cross-retail transactions). New inventory is registered with inventory management module 232, creating corresponding entries in database 205. A list of warehoused products can be generated for review by the retailer, and graphs of inventory levels can be generated to show changes in levels as a result of deliveries to customers and receipt of new inventory at warehouses to increase stock or replace those sent to customers. In addition to managing inventory in leased warehouse space, retailers can provide access to their own warehouses, such as storage of products in retail stores and other locations, using retail location module 233. Retail locations are registered with retail location module 233 similarly to ordinary warehouse registration, but retailers need not offer any space to lease. Instead, the retailers list inventory in their retail locations to be tracked in the same manner as leased-warehouse inventory, including fulfillment management. This allows retailers to efficiently deliver goods from their own retail locations directly to customers, especially nearby customers, as well as to offer their goods for cross-retailer fulfillment, in which a first retailer requests delivery of a product, and a second retailer provides a matching product for delivery (in exchange for appropriate payment.) Retailers can set prices for cross-retailer fulfillment using retail location module 233, or alternatively opt out of such fulfillment for some or all products in one or more locations.

FIG. 2D shows a detailed diagram of a subsystem for fulfillers 140 of FIG. 1. As in the case of the property holders and retailers, fulfillers can connect using a computing device, such as computer or a mobile device. Preferably, fulfillers connect using a mobile device, since mobile devices can be carried during and between delivery trips, allowing the location of fulfillers to be tracked. This tracking allows real-time identification of fulfillers who are well-positioned to respond quickly to a delivery request. The fulfiller computing device is provided processor-executable instructions, for example in the form of HTML, browser-executable code, device apps, or an API. The instructions, when executed, provide a fulfiller subsystem 140, as illustrated in FIG. 2D. The fulfiller subsystem comprises a mobile app 240, that enables fulfiller interactions with the fulfiller API 211. Fulfillers can sign up by sending registration information to fulfiller subsystem 140. The fulfiller can be, for example, a commercial delivery service, or a private individual. The fulfiller may register a vehicle to be used in deliveries. The fulfillment types offered can include truck- or car-based delivery, as well as delivery by other modes of transportation such as by foot, by bicycle, by boat, by aircraft, or by drone. Once registered, fulfillers set a proximity zone, corresponding to a geographical area in which they offer delivery services. This zone can be updated as desired, and different portions of a delivery zone can be given different prices; for example, a central zone near the fulfiller may be less expensive, while a peripheral zone may be more expensive, given the longer travel required. Fulfillers can also charge variable prices, such as per-mile fees. Fulfillers can also validate devices such as inventory scanner 245, which is used to scan codes associated with products during pick up or delivery. The inventory scanner may be a separate device from the mobile device of the fulfiller, or it may be the same device; for example, a smartphone can be used both for the signup, response and tracking features of the mobile app 240 and for the scanning features of inventory scanner 245 for example, by scanning barcodes or QR codes using an integrated camera, determining the associated code, then uploading the determination to the platform 110 for product identification and confirmation.

The mobile app 240 comprises tracking software which tracks the fulfiller in real time while the app 240 is running on the mobile device. This tracking may include, for example, GPS geolocation. The tracking information is relayed to fulfiller API 211, which uses it to determine the location of the fulfiller. This determination allows the fulfiller API 211 to recommend fulfillers to retailers based on their proximity to a warehouse, so as to minimize required travel time for pickup. The tracking of fulfillers also allows fulfiller API 211 to consolidate multiple deliveries (including deliveries for different retailers) to a single fulfiller, so as to avoid duplicative trips.

The fulfiller's inventory scanner 245 scans inventory codes when a product is picked up, and relays the information to fulfiller API 211 for update to the corresponding database entry in database 205. During delivery, delivery updates can be provided to the customer receiving the delivery or to the retailer, based on the tracking of the fulfiller, such as real-time updates on fulfiller position or written updates from the fulfiller (such as a note that the customer was not present to sign for a delivery). Upon delivery, a second scan is performed and corresponding data sent to the platform 110, and the fulfiller API 211 updates the database 205 to reflect a successful delivery. The fulfiller API also triggers invoicing, allowing appropriate payments to the fulfiller and billing to the retailer to be provided. The retailer is notified of the successful delivery, so that the customer may be informed that the delivery has been made.

FIG. 3 illustrates a process 300 by which a retailer provides product listings for cross-retailer inventory. This process may be performed by platform 110, receiving input over network 150 from a retailer subsystem 130.

In step 310, the platform 110 provides software for retailer subsystem 130; once the retailer installs the software on a computing device, the device sends a confirmation to platform 110, which receives the confirmation and provides a connection to allow the listing of products. The platform 110 queries the retailer to select warehouses for listing.

In step 320, the platform 110 receives retailer selection of one or more warehouses in which products are to be listed. This step may include registration of warehouses, as discussed above, and/or selection of already-registered warehouses. The warehouses can include storage spaces as well as retail facilities. The platform 110 then queries the retailer to select products for each warehouse to list.

In step 330, the platform 110 receives from the retailer a selection of one or more products in the one or more warehouses. This selection can include identification of new products, as described above, and/or selection of already registered products. The retailer can choose the number of each product to list, including setting a reserve level of products to hold back from listing. For each product selected, the platform 110 queries the retailer to determine price for cross-retailer fulfillment.

In step 340, the platform 110 receives a price selection for cross-retailer fulfillment. This selection can be a direct message from the retailer, or may be determined by the platform 110. For example, a retailer can provide an inventory cost for each product and gross margin percent desired, on a product-by-product or collective basis, and allow the platform to calculate appropriate prices for cross-retailer fulfillment. Steps 320-340 can repeated as needed until the retailer is finished listing products.

In step 350, the retailer is provided with a summary of product listed and product pricing for each warehouse selected, and given the chance to approve, modify, or cancel. If the retailer chooses to cancel, the process exits. If the retailer chooses to modify, the process returns to step 320, step 330, or step 340 as appropriate to the requested modification. If the retailer chooses to approve, the process continues to step 360.

In step 360, the platform 110 updates database 205, reflecting the retailer modifications, and generates a catalog by updating existing system-wide product listings to reflect the changes made by the retailer. The catalog can then be accessed by subscribed retailers to allow for cross-retailer fulfillment.

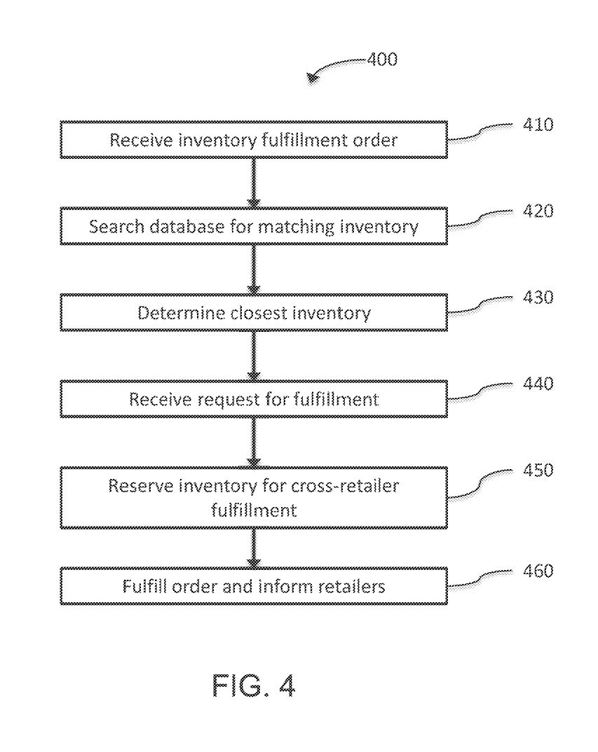

FIG. 4 illustrates a process 400 by which a first retailer can arrange the fulfillment of warehoused products of a second retailer. In step 410, the platform 110 receives an inventory fulfillment order from a first retailer. The fulfillment order identifies a product and a customer address for delivery. The first retailer may do an initial search of the retailer's inventory and indicate a price and time for self-fulfillment, or may use platform 110 to perform a such a search including listed inventory of the first retailer.

In step 420, the platform 110 checks database 205 for available inventory that matches the Selection. In step 430, products near to the delivery address are identified by the platform, and a list of products is generated to be sent to the first retailer. This list can include products of a second retailer. The platform calculates the corresponding prices and delivery times available for each such product and sends a list of options to the first retailer.

In step 440, the platform 110 receives a selection of an option from the first retailer. If the selection is of a product belonging to the first retailer, then ordinary fulfillment is performed. However, if the selection is of a second retailer's product (that is, a cross-retailer fulfillment request), then the second retailer is informed, and the corresponding product is reserved in step 450 for delivery from the second retailer's storage location.

In step 460, a fulfillment request is sent to fulfillers, and the fulfillers proceed to pick up and deliver the product to its destination. Upon pickup, the order is marked shipped in the database 205, and the corresponding stock value is adjusted appropriately. The delivery is tracked and confirmed as disclosed herein, and upon completion, the first and second retailers are informed and appropriate invoices are generated. The order is then marked as closed by the database 205.

FIG. 5 illustrates a method of warehouse fulfillment pricing based on fulfiller delivery time.

In step 510, a request is received from a retailer to deliver a product in a warehouse to a customer. The request includes product identification, delivery address, and pricing information, specifying a range of ask amounts representing payments to fulfillers based on time taken to deliver.

In step 520, the request is forwarded to a plurality of fulfillers in the geographical area of the warehouse and delivery address.

In step 530, responses are received from one or more fulfillers agreeing to the terms. The fulfillers may specify a projected delivery time, or may offer a new bid for price and/or delivery time, if the initial ask amounts are insufficient.

In step 540, the responses are collected and forwarded to the retailer, allowing the retailer to choose a fulfiller to handle the order. The retailer may also be provided with a list of fulfiller ratings, based on past retailer reviews.

In step 550, a selection is received from the retailer, specifying a particular fulfiller to make the delivery.

In step 560, an order is sent to the chosen fulfiller, indicating that the terms are agreed to. The fulfiller then proceeds to pick up the product and deliver it, using the tracking system and methods disclosed herein.

In step 570, delivery confirmation is received, and the retailer is informed. The retailer is given the option to rate the fulfiller, and such ratings can be compiled by the platform 110 for later reporting.

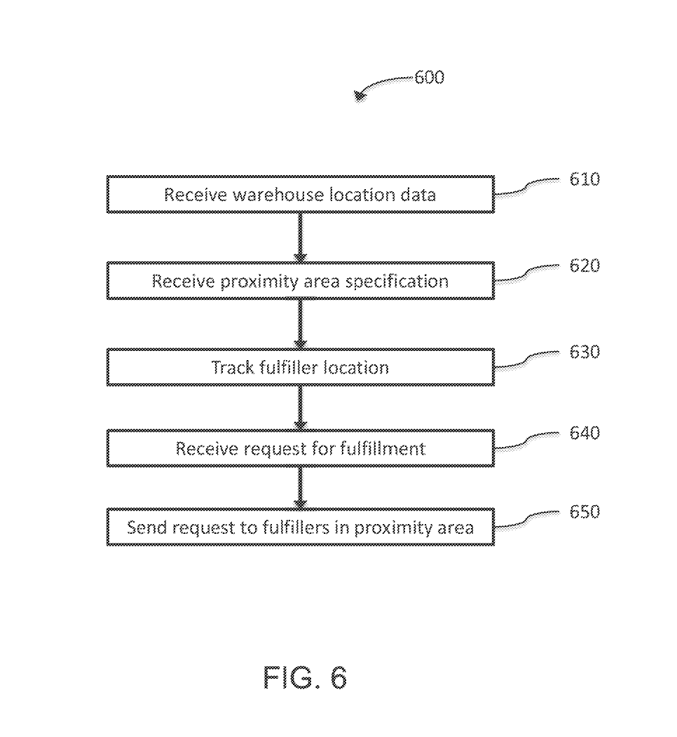

FIG. 6 illustrates a method of coordinating retailer and fulfiller orders in the delivery of products for a plurality of orders.

In step 610, a geolocation data are received from a retailer, identifying one or more warehouse locations. These warehouses can include retailer warehouses and/or warehouses leased through system 100.

In step 620, the retailer specifies a proximity area around each warehouse, corresponding to an area in which to notify fulfillers of order requests. The location and proximity area are stored in database 205.

In step 630, geolocation tracking data is received from fulfillers, allowing the locations of fulfillers to be compared to the proximity area of each warehouse. Fulfillers not running the appropriate app to allow tracking of a device are treated as not present.

In step 640, a request for delivery from a warehouse to an address is received.

In step 650, a fulfillment notification is sent to fulfillers within the proximity area of the warehouse. If no fulfillers are present, or no fulfillers present respond within a predetermined time, the proximity area may be temporarily expanded until a response is received, or a notification of no fulfillers available may be sent to the retailer. Otherwise, at this point, fulfiller selection, order placement, and delivery can proceed, for example, starting with step 530 of process 500.

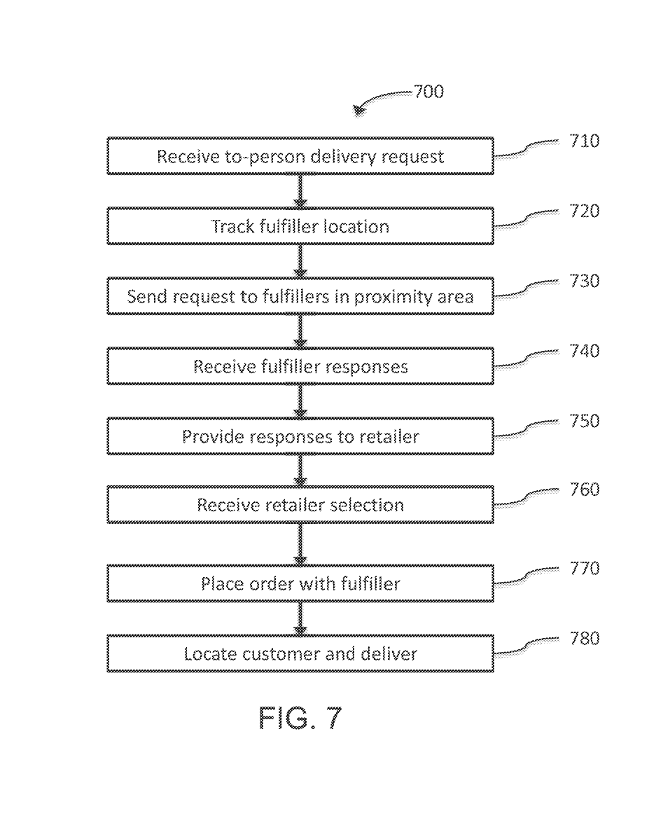

A process of fulfiller geolocation tracking, selection, and delivery to the actual location of a customer is illustrated in FIG. 7.

In step 710, a request is received from a retailer to deliver a product in a warehouse to a customer. The request includes product identification and pricing information, specifying a range of ask amounts representing payments to fulfillers based on time taken to deliver. The request also specifies to-person delivery for a customer, and specifies the customer's location and a method of contacting or locating the customer, such as a telephone number or a mobile device tracking identification used by a mobile device of the customer.

In step 720, geolocation tracking data is received from fulfillers, allowing the locations of fulfillers to be compared to the proximity area of each warehouse. Fulfillers not running the appropriate app to allow tracking of a device are treated as not present.

In step 730, a fulfillment notification is sent to fulfillers within the proximity area of the warehouse. If no fulfillers are present, or no fulfillers present respond within a predetermined time, the proximity area may be temporarily expanded until a response is received, or a notification of no fulfillers available may be sent to the retailer.

In step 740, responses are received from one or more fulfillers agreeing to the terms. The fulfillers may specify a projected delivery time, or may offer a new bid for price and/or delivery time, if the initial ask amounts are insufficient.

In step 750, the responses are collected and forwarded to the retailer, allowing the retailer to choose a fulfiller to handle the order. The retailer may also be provided with a list of fulfiller ratings, based on past retailer reviews.

In step 760, a selection is received from the retailer, specifying a particular fulfiller to make the delivery.

In step 770, an order is sent to the chosen fulfiller, indicating that the terms are agreed to. The fulfiller then proceeds to pick up the product and deliver it, using the tracking system and methods disclosed herein.

In step 780, the fulfiller locates the customer, for example, by contacting the customer or by tracking geolocation data provided by a device of the customer. If the customer cannot be located or is outside a proximity zone of the fulfiller, the fulfiller delivers to the customer's address instead. After completing delivery, the fulfiller delivery confirmation is received by the platform 110, and the retailer is informed. The retailer is given the option to rate the fulfiller, and such ratings can be compiled by the platform 110 for later reporting.

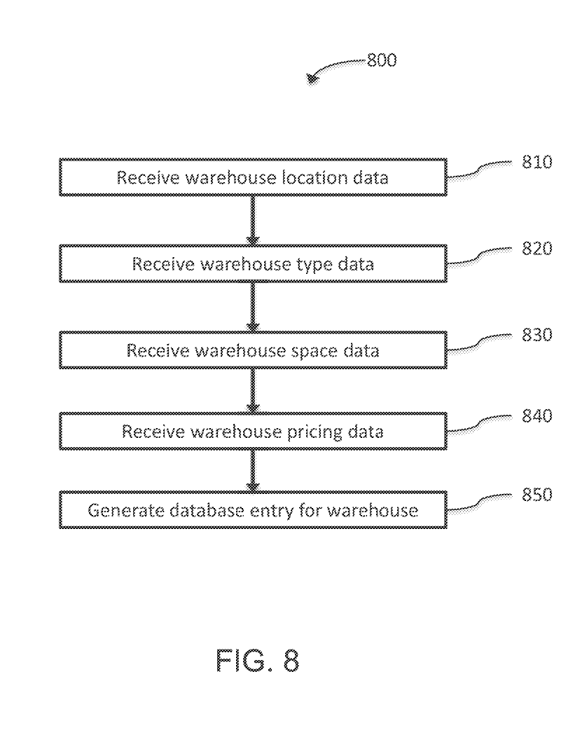

FIG. 8 illustrates a method of warehouse space listing. In step 810, warehouse location data are received identifying a warehouse that a user wishes to lease space in.

In step 820, warehouse type data are received identifying the type of warehousing space available. The warehouse type data can include the categories described with regards to FIG. 2B, including storage or facility type.

In step 830, warehouse space data are received, identifying available space in the warehouse, as well as listing terms for lease such as times available and required lease length.

In step 840, pricing data are received, which may include specification of pricing as a function of amount or type of space leased, term of lease, or other user-specified preferences.

In step 850, a database entry is generated in database 205, identifying the warehouse as available for lease, including the terms specified by the user, for example, in steps 810-840.

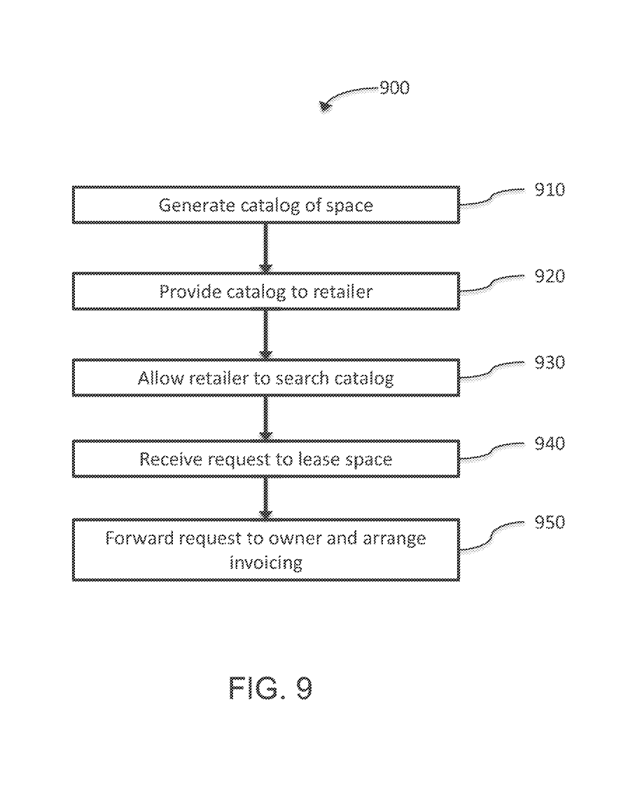

FIG. 9 illustrates a method of allocation of warehousing space. In step 910, a catalog is generated based on warehouse listing entries in database 205. The catalog lists warehouse location, available space, price, and other terms such as time available and required lease duration for leased space in the warehouse.

In step 920, the catalog is provided to the retailer. This can include providing the retailer with a search functionality in step 930, by which the retailer can search for available space based, for example, on price, location, or other terms.

In step 940, a retailer selection is received, identifying an offer accepted by the retailer to lease space in a particular warehouse.

In step 950, the request is forwarded to the owner or other representative who is offering the space for lease. Once both parties have agreed, invoicing is set up for billing and payment to the respective parties. The retailer can also be provided with information such as codes for access to the warehouse, so that the retailer can arrange to have goods delivered there for storage.

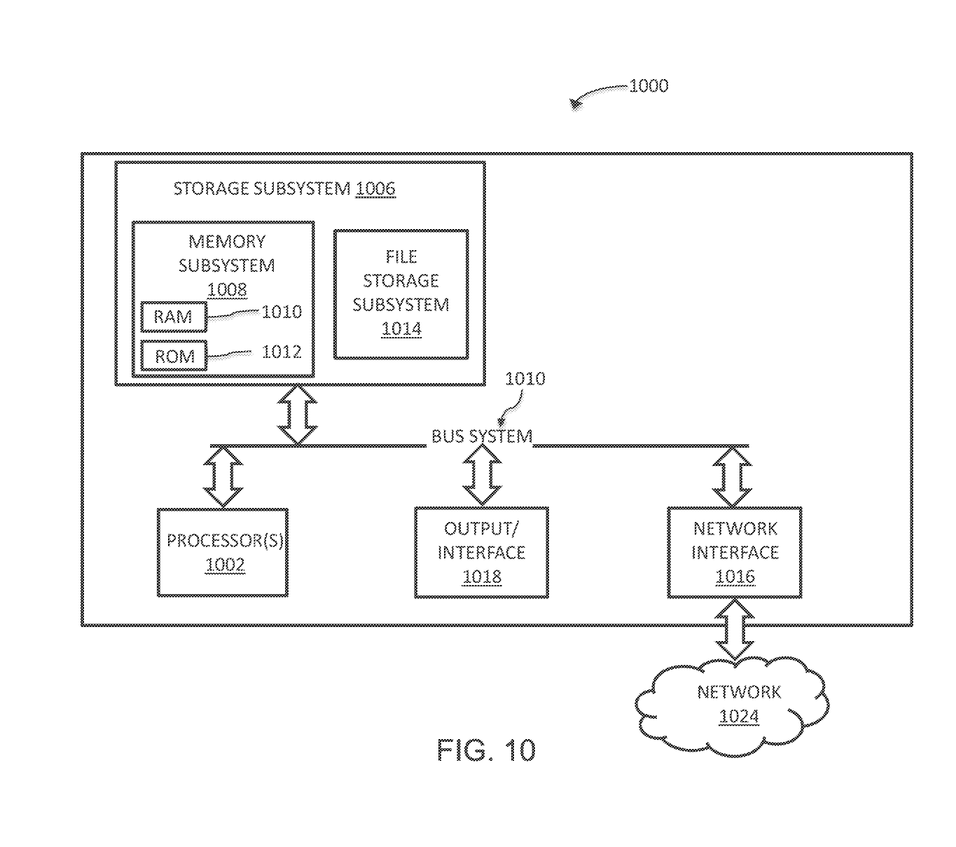

FIG. 10 is a simplified block diagram of a data processing system 1000 that may be used in executing methods and processes described herein. The data processing system 1000 typically includes at least one processor 1002 that communicates with one or more peripheral devices via bus subsystem 1004. These peripheral devices typically include a storage subsystem 1006 (memory subsystem 1008 and file storage subsystem 1014), a set of user interface input and output devices 1018, and an interface to outside networks 1016. This interface is shown schematically as “Network Interface” block 1016, and is coupled to corresponding interface devices in other data processing systems via communication network 1024. Network 1024 can correspond to network 150 above. Data processing system 1000 can include, for example, one or more computers, such as a personal computer, workstation, mainframe, laptop, and the like, as well as mobile devices such as smartphones and tablets. A plurality of devices may be connected to each other via network 1024; for example, the property holders 120, retailers 130, and fulfillers 140 of FIG. 1 may each comprise one or more computing devices, including mobile devices, coupled to network 1024, and data processing system 1000 may correspond to the platform 110.

The user interface input devices 1018 are not limited to any particular device, and can typically include, for example, a keyboard, pointing device, mouse, scanner, interactive displays, touchpad, joysticks, touchscreen, microphone, etc. Similarly, various user interface output devices can be employed in a system of the invention, and can include, for example, one or more of a printer, display (e.g., visual, non-visual) system/subsystem, controller, projection device, audio output, and the like.

Storage subsystem 1006 maintains the basic required programming, including computer readable media having instructions (e.g., operating instructions, etc.), and data constructs. The program modules discussed herein are typically stored in storage subsystem 1006. Storage subsystem 1006 typically includes memory subsystem 1008 and file storage subsystem 1014. Memory subsystem 1008 typically includes a number of memories (e.g., RAM 1010, ROM 1012, etc.) including computer readable memory for storage of fixed instructions, instructions and data during program execution, basic input/output system, etc. File storage subsystem 1014 provides persistent (non-volatile) storage for program and data files, and can include one or more removable or fixed drives or media, hard disk, floppy disk, CD-ROM, DVD, optical drives, and the like. One or more of the storage systems, drives, etc may be located at a remote location, such coupled via a server on a network or via the internet/World Wide Web. The databases disclosed herein may include data stored in file storage subsystem 1014. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

The data processing aspects of the methods described herein can be implemented in digital electronic circuitry, or in computer hardware, firmware, software, or suitable combinations thereof. Data processing apparatus can be implemented in a computer program product tangibly embodied in a machine-readable storage device for execution by a programmable processor. Data processing steps can be performed by a programmable processor executing program instructions to perform functions by operating on input data and generating output. The data processing aspects can be implemented in one or more computer programs that are executable on a programmable system, the system including one or more programmable processors operably coupled to a data storage system. Generally, a processor will receive instructions and data from a read-only memory and/or a random access memory. Storage devices suitable for tangibly embodying computer program instructions and data include all forms of nonvolatile memory, such as: semiconductor memory devices, such as EPROM, EEPROM, and flash memory devices; magnetic disks such as internal hard disks and removable disks; magneto-optical disks; and CD-ROM disks.

Although the detailed description contains many specifics, these should not be construed as limiting the scope of the disclosure but merely as illustrating different examples and aspects of the present disclosure. It should be appreciated that the scope of the disclosure includes other embodiments not discussed in detail above. Various other modifications, changes and variations which will be apparent to those skilled in the art may be made in the arrangement, operation and details of the method and apparatus of the present disclosure provided herein without departing from the spirit and scope of the invention as described herein.

While preferred embodiments of the present disclosure have been shown and described herein, it will be obvious to those skilled in the art that such embodiments are provided by way of example only. Numerous variations, changes, and substitutions will be apparent to those skilled in the art without departing from the scope of the present disclosure. It should be understood that various alternatives to the embodiments of the present disclosure described herein may be employed without departing from the scope of the present invention. Therefore, the scope of the present invention shall be defined solely by the scope of the appended claims and the equivalents thereof.

What is claimed is:

1. A warehousing and delivery fulfillment system, the system comprising:
a computer network;
a non-transitory computer-readable storage medium;
a processor; and memory, including instructions executable by the processor to cause the system to at least:
receive, from the computer network, property listings from a plurality of property managers, each property listing identifying a warehousing property;
generate, based on the received property listings, a database of warehouse listings corresponding to the identified warehousing properties;
receive, from the computer network, storage space requests from one or more retailers, each storage space request identifying a product to be stored;
assign each storage space requests to a corresponding warehousing space of one or more of the warehousing properties;
generate a product database identifying the products assigned to each warehouse;
receive, from the computer network, a purchase order requesting that a product be delivered to a customer address;
select a product from the product database that corresponds to the requested product wherein the selection is determined based on selection criteria including the customer address and the warehouse to which the product is assigned;
send, using the computer network, a delivery request to deliver to the customer the selected product.

2. The system of claim 1, wherein each warehouse listing identifies a warehouse location.

3. The system of claim 1, wherein each warehouse listing identifies a warehouse storage capacity.

4. The system of claim 1, wherein the purchase order is from a first retailer and wherein the selected product is a product of a second retailer.

5. The system of claim 4, wherein the product database comprises price listings for third-party fulfillment, and wherein the selection criteria include said price listings for third-party fulfillment.

6. The system of claim 5, wherein the processor is configured to receive third-party fulfillment prices from the one or more retailers, and wherein the price listings for third-party fulfillment are determined from said received third-party fulfillment prices.

7. The system of claim 3, wherein the system is configured to record in the database a total storage space for each warehouse listing.

8. The system of claim 3, wherein the system is configured to track available storage space for each warehouse listing in the database.

9. The system of claim 1, wherein each storage space request identifies a number or products to be stored and a space required for product storage.

10. The system of claim 1, wherein each product is identified by a barcode.

11. The system of claim 10, wherein the system is further configured to receive barcode scans identifying product arrivals and departures from a warehousing property.

12. The system of claim 11, wherein the system is configured to track inventory for a warehousing property by incrementing a product count in response to each product arrival and decrementing said product count in response to each product departure.

13. The system of claim 1, wherein the system is configured to identify, for each warehouse listing, an available storage space, a storage price, and a storage location.

14. The system of claim 1, wherein the system is further configured to identify a storage type for each warehouse listing.

15. The system of claim 13, wherein the system is configured to allow a user to search for storage space in response to at least one of the available storage space, the storage price, or the storage location.

16. The system of claim 13, wherein the system is configured to allow a user to request storage space based on one or more of an amount of required storage space, a maximum storage price, or a preferred storage location, and wherein the system identifies one or more warehousing options based on said user request.

17. The system of claim 1, wherein the system is configured to:
receive, from the computer network, fulfiller data including availability, pricing, and delivery area data for a plurality of delivery fulfillers;
determine, based on a location of the identified warehousing space, one or more delivery fulfillers for which the identified warehousing space and the customer address are within a corresponding delivery range;
send, using the computer network, a fulfillment request to the one or more delivery fulfillers identifying the requested delivery;
receive, from the computer network, one or more responses from the one or more delivery fulfillers;
send, using the computer network, the delivery request to a delivery fulfiller of the one or more delivery fulfillers based on the responses.

18. The system of claim 17, wherein the delivery fulfiller is determined by comparing the fulfiller responses to delivery preferences specified by the retailer for which the product is to be delivered.

19. The system of claim 18, wherein the delivery preferences comprise a delivery price preference and a delivery time preference.

20. The system of claim 18, wherein the delivery preferences comprise a fulfiller rating preference.

21. A method for warehousing and delivery fulfillment, the method comprising:
receiving, from a computer network, property listings from a plurality of property managers, each property listing identifying a warehousing property;
generating, based on the received property listings, a database of warehouse listings corresponding to the identified warehousing properties;
receiving, from the computer network, storage space requests from one or more retailers, each storage space request identifying a product to be stored;
assigning each storage space requests to a corresponding warehousing space of one or more of the warehousing properties;
generating a product database identifying the products assigned to each warehouse;
receiving, from the computer network, a purchase order requesting that a product be delivered to a customer address;
selecting a product from the product database that corresponds to the requested product wherein the selection is determined based on selection criteria including the customer address and the warehouse to which the product is assigned; and
sending, using the computer network, a delivery request to deliver to the customer the selected product.

22. The method of claim 21, wherein each warehouse listing identifies a warehouse location.

23. The method of claim 21, wherein each warehouse listing identifies a warehouse storage capacity.

24. The method of claim 21, wherein the purchase order is from a first retailer and wherein the selected product is a product of a second retailer.

25. The method of claim 24, wherein the product database comprises price listings for third-party fulfillment, and wherein the selection criteria include said price listings for third-party fulfillment.

26. The method of claim 25, further comprising receiving third-party fulfillment prices from the one or more retailers, and determining the price listings for third-party fulfillment from said received third-party fulfillment prices.

27. The method of claim 23, further comprising recording in the database a total storage space for each warehouse listing.

28. The method of claim 23, further comprising tracking available storage space for each warehouse listing in the database.

29. The method of claim 21, wherein each storage space request identifies a number or products to be stored and a space required for product storage.

30. The method of claim 21, wherein each product is identified by a barcode.

31. The method of claim 30, further comprising receiving barcode scans identifying product arrivals and departures from a warehousing property.

32. The method of claim 31, further comprising tracking inventory for a warehousing property by incrementing a product count in response to each product arrival and decrementing said product count in response to each product departure.

33. The method of claim 21, further comprising identifying, for each warehouse listing, an available storage space, a storage price, and a storage location.

34. The method of claim 21, further comprising identifying a storage type for each warehouse listing.

35. The method of claim 33, further comprising allowing a user to search for storage space in response to at least one of the available storage space, the storage price, or the storage location.

36. The method of claim 33, further comprising allowing a user to request storage space based on one or more of an amount of required storage space, a maximum storage price, or a preferred storage location, and identifying one or more warehousing options based on said user request.

37. The method of claim 21, further comprising:
receiving, from the computer network, fulfiller data including availability, pricing, and delivery area data for a plurality of delivery fulfillers;
determining, based on a location of the identified warehousing space, one or more delivery fulfillers for which the identified warehousing space and the customer address are within a corresponding delivery range;
sending, using the computer network, a fulfillment request to the one or more delivery fulfillers identifying the requested delivery;
receiving, from the computer network, one or more responses from the one or more delivery fulfillers;
sending, using the computer network, the delivery request to a delivery fulfiller of the one or more delivery fulfillers based on the responses.

38. The method of claim 3 wherein the delivery fulfiller is determined by comparing the fulfiller responses to delivery preferences specified by the retailer for which the product is to be delivered.

39. The method of claim 38, wherein the delivery preferences comprise a delivery price preference and a delivery time preference.

40. The method of claim 38, wherein the delivery preferences comprise a fulfiller rating preference.
